(19) United States
(12) Patent Application Publication
(10) Pub. No.: US 2021/0365098 A1
(43) Pub. Date: Nov. 25, 2021

(54) SAFETY MONITORING OR POWER-UP AND/OR POWER-DOWN OF A POWER MANAGEMENT DEVICE

(71) Applicant: NXP USA, Inc., Austin, TX (US)

(72) Inventors: Loic Hureau, Toulouse (FR); Jean-Philippe Meunier, Ayguesvives (FR)

(21) Appl. No.: 17/313,311

(22) Filed: May 6, 2021

(30) Foreign Application Priority Data
May 20, 2020 (EP) 20305528.0

(51) Int. Cl. G06F 1/3206; G06F 1/28; H02M 3/158; G06F 1/18

(52) U.S. Cl. CPC G06F 1/3206; G06F 1/189; H02M 3/158; G06F 1/28

(57) ABSTRACT

A power management device is disclosed comprising a power management processing unit and a safety unit; the power management processing unit comprising: a plurality of power units each configured to supply current from an input, and a main sequencer configured to implement a power-up sequence in and a power-down; the safety unit comprising: voltage monitors each configured to monitor the output voltage of a power unit; wherein the safety unit further comprises a safety sequencer configured to store sequence data; and wherein the safety unit further comprises a safety processing unit, configured to use the sequence data stored in the safety sequencer to monitor the plurality of power units during the power-up sequence by means of the respective voltage monitors. Associated systems and methods are also disclosed.

### FIELD

The present disclosure relates to power management devices, systems including power management devices, and methods of operating the same.

### BACKGROUND

Modem power management devices and power management ICs (PMICs) often include safety features to ensure the proper monitoring and/or management of both the PMIC itself, and any externally connected regulators or converters and any application processor or other peripherals driven or powered by the PMIC, in case of an interruption to the power supply. This may include voltage monitoring of the one or more outputs from the power management PMIC. Safe power management is achieved by an independent safety monitoring unit (iSMU) which forms part of the PMIC power management processing.

Monitoring the device during power-up and power-down however remains a challenge.

### SUMMARY

According to a first aspect of the present disclosure, there is provided a power management device comprising a power management processing unit and a safety unit; the power management processing unit comprising: an input configured to receive current at an input voltage; a plurality of power units each configured to supply current from the input at a respective output voltage, and a main sequencer configured to implement a power-up sequence in which the plurality of power units are powered-up to supply said respective current in a predetermined sequence; the safety unit comprising: a plurality of voltage monitors each configured to monitor the output voltage of a respective one of the power units; a power-good unit, configured to provide a power-good output signal indicative of normal operation of the power management device; and optionally a fail-state unit, configured to provide an output indicative of a fail-state of the power management device; wherein the safety unit further comprises a safety sequencer configured to store, or otherwise access, sequence data; and wherein the safety unit further comprises a safety processing unit, configured to use the sequence data stored in the safety sequencer to monitor the plurality of power units during the power-up sequence by means of the respective voltage monitors, and to provide an output, optionally to at least one of the power-good unit and the fail-state unit, in response to the monitoring.

By providing a safety sequencer configured to store sequence data in the safety unit separate from, that is to say independent of, the storage of sequence data in the power management processing unit, the safety monitoring may be extended to include the power-up stage of the power management device, relatively independently from the power management processing unit. This may extend the capability of the safety unit. The safety sequencer may be separate from or may be part of the safety processing unit. Typically, the safety unit is powered from one of the regulators or DC-DC converters on the power management processing unit; however, in other embodiments, the safety unit may be powered by a dedicated regulator. The safety processing unit is, in general terms a processing unit dedicated to monitoring for correct operation of the device.

In one more or more embodiments, the safety unit comprises one-time programmable, OTP, memory. Use of one-time programmable memory allows the designer to customise the safety sequencer to match the main sequencer controlling start-up of the power units, which is also typically implemented in one-time programmable memory. In other embodiments other non-volatile memory types may be used. In other embodiments, that sequence data may be accessed from external storage using external pins.

In one or more embodiments, the safety processing unit is further configured to monitor the power units during a power-down sequence by means of the respective voltage monitors, and to provide an output to at least one of the power-good unit and the fail-state unit in response to the monitoring. The power management device according to embodiments may thus also allow safety monitoring to extend to a power-down stage, again relatively independent from the power management processing unit. The information may also be stored in a register that will be used on the next power-up to inform the application processor of the power-down issue

In one or more embodiments, the safety processing unit is configured to monitor the power plurality of power units during the power-up sequence by each voltage monitor comparing the output voltage of the respective power unit with a respective undervoltage threshold voltage, and the safety processing unit is configured to provide a threshold-passed signal indicative of whether the output voltage exceeds the respective undervoltage threshold voltage. It will be appreciated that this or these undervoltage threshold voltage or voltages may be the same as or different from the undervoltage threshold voltage or voltages used by the safety unit during normal operation of the device. The safety unit may thus be able to check that each of the regulators or the DC-DC converters has been appropriately discharged before confirming that the power-down has been successful.

In one or more embodiments the safety sequencer is configured to store an expected sequence in which the power units should power-up, and the safety processing unit is configured to provide an output to the power-good unit in response to the threshold-passed signals indicating the power unit powers up in expected sequence, and to the fail-state unit otherwise.

In other embodiments, the safety sequencer is configured to store an expected power-up interval for each power unit, and the safety processing unit is configured to provide an output to the power-good unit in response to receiving each of the respective threshold-passed signals indicating the power units have powered up within the respective predetermined interval in the same sequence as the expected sequence unit, and to the fail-state unit otherwise.

In one or more embodiments the safety processing unit is configured to provide an output to the fail-state unit in response to any one or more of the threshold-passed signals indicated that the respective power unit falls below the respective threshold after being powered up. This may be used, for example, to allow the safety unit to do some diagnostic tests. It may not be required to prevent the application processor from starting.

In one or more embodiments the safety unit further comprises an analogue built in self-test, ABIST, circuit configured to test for correct operation of the voltage monitors. Furthermore, the safety unit may further comprise a logic built in self test, LBIST, circuit configured to test for correct operation of the safety monitoring unit and the safety sequencer.

In one or more embodiments, the plurality of power units comprises a plurality of DC-DC converters and at least one low drop out, LDO, voltage regulator or LDO switch.

The power management processing unit may further comprise a communication interface for communicating with an application processor, and at least one of the plurality of power units may be configured to provide power to the application processor.

According to a second aspect of the present disclosure, there is provided a method of operating a power management device comprising a power management processing unit having a plurality of power units, and a safety unit having a plurality of voltage monitors, the method comprising: powering up each of the plurality of power units according to a predetermined sequence stored in a main sequencer; comparing an output voltage of the respective power unit while it is being powered up with a respective undervoltage threshold by means of a respective one of the voltage monitors, and providing a signal to a safety sequencer in dependence on whether the output voltage exceeds the respective undervoltage threshold; comparing the signals with a set of expected signals stored in the safety sequencer; providing a power-good signal in response to all the respective signals matching the set of expected signals; and providing a fail-state signal in response to any of the respective signals not matching the set of expected signals. The fail-state signal may take one of a variety of forms. For instance, it can be a pin signal or flag register, the processor can then use a communication bus, such as the I2C bus to do some checking. Typically, the reaction to a wrong start-up sequence may be programmable via OTP and depend on the specific application or use case.

According to a further aspect of the present disclosure, there is provided an interrelated method to the second aspect, this method of operating a power management device comprising a power management processing unit having a plurality of power units, and a safety unit having a plurality of voltage monitors, the method comprising: powering down each of the plurality of power units according to a predetermined sequence stored in a main sequencer; comparing an output voltage of the respective power unit while it is being powered down with a respective power-down voltage threshold by means of a respective one of the voltage monitors, and providing a signal to a safety sequencer in dependence on whether the output voltage exceeds the respective power-down threshold; comparing the signals with a set of expected signals stored in the safety sequencer; providing a power-down-good signal in response to all the respective signals matching the set of expected signals; and providing a fail-state signal in response to any of the respective signals not matching the set of expected signals.

There may be provided a computer program, which when run on a computer, causes the computer to configure any apparatus, including a circuit, controller, sensor, filter, or device disclosed herein or perform any method disclosed herein. The computer program may be a software implementation, and the computer may be considered as any appropriate hardware, including a digital signal processor, a microcontroller, and an implementation in read only memory (ROM), erasable programmable read only memory (EPROM) or electronically erasable programmable read only memory (EEPROM), as non-limiting examples. The software implementation may be an assembly program.

The computer program may be provided on a computer readable medium, which may be a physical computer readable medium, such as a disc or a memory device, or may be embodied as another non-transient signal.

These and other aspects of the invention will be apparent from, and elucidated with reference to, the embodiments described hereinafter.

### BRIEF DESCRIPTION OF DRAWINGS

Embodiments will be described, by way of example only, with reference to the drawings, in which

FIG. 1 shows a block diagram of a power management device according to one or more embodiments of the present disclosure;

FIG. 2 shows a block diagram of the power management device of FIG. 1 in a system;

FIG. 3 shows a state machine diagram of each of a power management processing units and of a safety unit according to one or more embodiments;

FIG. 4 shows the start-up sequence of a power management device;

FIG. 5 shows a flow diagram of a method according to one or more embodiments; and

FIG. 6 shows a flow diagram of a further method according to one or more embodiments.

It should be noted that the Figures are diagrammatic and not drawn to scale. Relative dimensions and proportions of parts of these Figures have been shown exaggerated or reduced in size, for the sake of clarity and convenience in the drawings. The same reference signs are generally used to refer to corresponding or similar features in modified and different embodiments

### DETAILED DESCRIPTION OF EMBODIMENTS

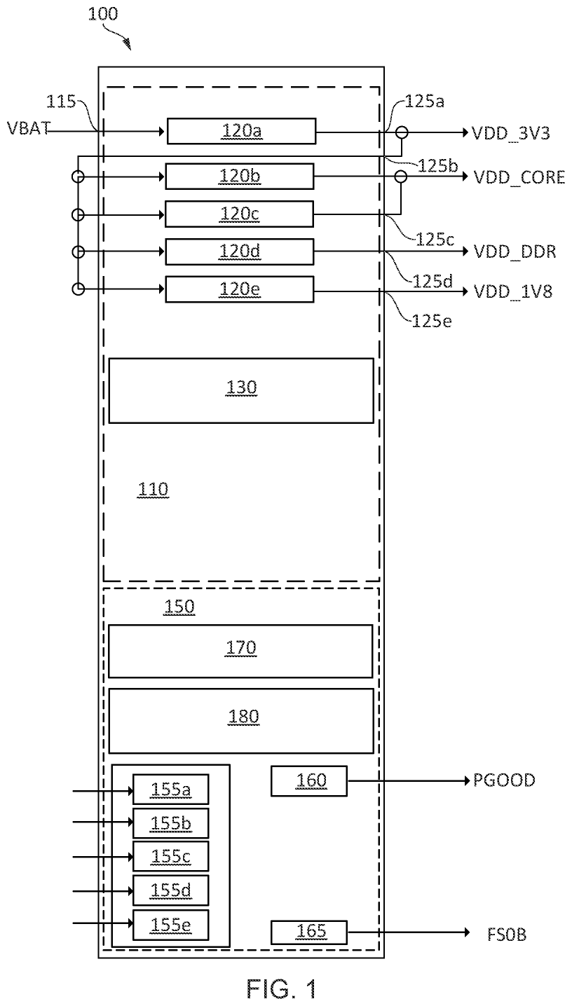

FIG. 1 illustrates a power management device 100 according to one or more embodiments of the present disclosure. The power management device 100 may be implemented as a stand-alone integrated circuit, and thus may also be referred to as a power management integrated circuit (PMIC) or may form part of a larger, integrated device.

As shown, the power management device comprises two separate domains. A first domain is a power management processing unit 110, and the second domain is a safety unit 150.

The power management processing unit 110 comprises: an input 115 configured to receive current at an input voltage (VBAT). Input 115 may be connected in use to a battery for supplying an input power, typically at a battery voltage, to the PMIC. The power management processing unit 110 further comprises a plurality of power units, shown at 120a, 120b . . . 120e, each configured to receive voltage or current from the input, and to supply voltage or current at a respective output voltage, shown at outputs 125a, 125b, . . . 125e. The output voltages may all be different, or may, as shown in FIG. 1 at 125b and 125c sometimes be common, or parts of a multiphase regulator. Although typically all the DC-DC converters and regulators are integrated into the same integrated circuit, one or more of the converters or regulators of the power management device may be “off-chip”. That is to say, they may be manufactured as either a separate IC, or having one or more of their component parts as external components, The term “device” as used herein, may thus cover two or more ICs, one of which is a main PMIC and the other or others comprise one or more regulators or DC-DC converters. The output voltages will depend on the application of the PMIC. For a non-limiting example application in which the PMIC is used to provide power to an application processor and at least one external memory device, in an automobile environment, the voltages may be chosen to be 3.3V (shown at V_{DD_3V3}), a core operating voltage of the application processor (shown at V_{DD_CORE}), a 1.8V supply (shown at V_{DD_1V8}), and a supply for Double Data Rate (DDR) memory . . . (shown at V_{DD_DDR}).

As will be familiar to the skilled person, the power units 120a, 120b, 120e may take various forms. In particular they may be implemented as DC-DC converters, or be implemented as other voltage regulators, such as so-called low drop out (LDO) voltage regulators. Other voltage regulators or other types of voltage regulators (not shown in FIG. 1) may be included in addition or as alternatives. The DC-DC converters are typically buck converters, but other type of DC-DC converters, such as boost converters, are not excluded. In the example application mentioned wherein the PMIC is used to power an applications processor and peripherals in an automobile environment, a high-voltage (HV) DC-DC buck converter 120a may be used to supply the 3.3 V output. Similarly, a DC-DC buck converter 120b may be used to supply the voltage DD_CORE for the application processor core. As will be familiar to the skilled person, two or more buck converters (two are shown—120b and 120c) may be used for this purpose with their outputs connected in common. Furthermore, a separate DC-DC buck converter 120d may be used to supply the DDR voltage. Finally, a LDO voltage regulator 120e may be used to supply the 1.8V supply. Of course, this example is nonlimiting and other numbers of power units, operating at the same or other voltages may be utilised depending on the specific application. The DC-DC and other regulators may all have, as their input, the input 115 for connection to VBAT; alternatively, and as shown, one or more of the DC-DC convertors, may be only indirectly connected to the input 115; for example, as shown, they may use the output of the HV DC-DC buck converter as their own input. Thus, for example, the lower voltage supplies may be provided with a smaller step-down ratio.

The power management processing unit also includes a main sequencer 130. As will be discussed in more detail hereinbelow, two of the functions of the main sequencer are to implement a power-up sequence in which the plurality of power units 120a, 120b, . . . 120e are powered up in a predetermined sequence and to implement a power-down sequence in which the plurality of power units are powered-down in a predetermined sequence. The main sequencer may also determine the output voltage of some or each of the regulators. The main sequencer may be implemented using non-volatile memory such as, without limitation, one-time programmable (OTP) memory. In such an example, during the customisation for the specific application, the power-up sequence instructions and the power-down sequence instructions are burnt into the OTP memory. The instructions can then be loaded into for example mirror registers to implement (in the case of the main sequencer), or monitor (in the case of the safety sequencer discussed in more detail below) the power-up and/or power-down.

As already mentioned, in addition to the power management processing unit 110, the power management device 100 or PMIC includes a second domain, being a safety unit 150. The safety unit 150 includes a plurality of voltage monitors 155a, 155b . . . 155e, each configured to monitor the output voltage of a respective one of the power units. That is to say, there is a voltage monitor associated with each of the power units. In one or more example embodiments, the voltage monitors are each implemented as a separate circuit—typically in the analogue domain. Each of voltage monitors is configured to be able to compare the output of the respective power unit with one or more threshold voltages. For instance, the voltage monitor may include an under-voltage threshold, which is compared with the respective output voltage in order to ensure that the power unit is providing power which is not too far below the design voltage. As a nonlimiting example, the under-voltage threshold for the 3.3 V supply may be set to be equal to 3.0 V, in order to be sure that the voltage is being supplied at no less than 90% of the design voltage. In other embodiments, other thresholds may be used. The threshold may be set as a percentage of the design voltage, or as an absolute difference from the design voltage. Similarly, the voltage monitor may be provided with an over-voltage threshold, in order to detect potentially damaging over-voltages. In the above nonlimiting example, the over-voltage threshold may be set to be 3.9 V, in order to be confident that the voltage is being supplied as no more than 120% of the design voltage. Again, in other embodiments, other thresholds may be used. The threshold may be set as a percentage of the design voltage, or as an absolute difference from the design voltage.

Whereas the voltage monitors have been described above as being physically distinct units arranged such that there is a separate voltage monitor for each of the power units, the skilled person will appreciate that in other embodiments, this may be a logical arrangement only, and the same physical circuitry may be implemented to operate as two or more of the voltage monitors. For example, a single circuit may be arranged so the same physical voltage monitor circuit may be switched between a plurality of circuit configurations to monitor the voltage of two or more of the power units. However, although this may save circuitry, in general it is not preferred, since there may be a delay between a failure in a particular circuit, and that circuit being multiplexed for monitoring: the consequent loss of “real time” monitoring may be, in some circumstances, not acceptable.

The safety unit further comprises a power-good unit 160, configured to provide a power-good output signal PGOOD indicative of normal operation of the power management device. The power-good output signal PGOOD is typically provided at an output pin of the PMIC, and may be used to reset the application processor when needed.

The safety unit further comprises a fail-state unit 165, configured to provide an output FS0B indicative of a fail-state of the power management device. The fail-state output signal FS0B is typically provided at an output pin of the PMIC, and may be used to notify the applications processor and/or other peripherals of a fault.

As already mentioned above, the safety unit may be powered from the power management processor unit, for instance from a dedicated LDO. Furthermore, the safety unit may generate its own power supplies.

According to one or more embodiments of the present disclosure, the safety unit further comprises a safety sequencer 170, configured to store sequence data. The sequence data includes the power-up sequence which is also stored in the main sequencer 130, and a safety processing unit 180. As a minimum the safety sequencer 170 stores the order in which the power units should power-up. The safety sequencer may in addition store further information. For example, the safety sequencer may store data corresponding to the under-voltage threshold for each of the power units. Furthermore, the safety sequencer may store data corresponding to the overvoltage threshold for each of the power units. Furthermore, the safety sequencer may store data corresponding to a power-down threshold—for example if a power unit is powered down, its output voltage will fall and the power-down threshold may correspond to the voltage below which the output must have fallen for the system to consider that the power unit has properly powered down. Moreover, in one or more embodiments, the safety sequencer may store timing information, such as time-limits: in particular, powering up a power unit takes a finite time: there may be a time limit by which time the power unit would have been expected to have fully powered up, and in the case that the output voltage from the power unit does not rise above the undervoltage threshold within this time limit, the safety processing unit 180 may report a fault. The skilled person will appreciate that the timing information may be baselined from a start of the overall power-up sequence, or relate to the expected or maximum time for an individual power unit power-up.

The safety processing unit 180 comprises a sequencer processing logic. The sequencer processing logic is configured to use the sequence data stored in safety sequencer to monitor the plurality of power units during the power-up sequence by means of the respective voltage monitors, and to provide an output to at least one of the power-good unit and the fail-state unit in response to the monitoring. The processing logic may be simple, for instance, it may just apply the comparisons. In one or more other embodiments, the processing logic may include additional functionality, for instance it may include latch functionality, or a timed-latch functionality.

The safety processing unit 180 may include other safety processing functions, such as will be familiar to the skilled person. In particular the safety processing unit 180 may include known functionality of an independent safety monitoring unit (iSMU). The safety monitoring unit is independent in the sense that its operation is not necessarily dependent on correct functioning of the power management processing unit. Typically in known safety power management devices and safety PMICs this logic unit monitors the state of the power unit such as DC-DC converters and LDO regulators using the voltage monitor 155a, 155b . . . 155e during normal operation of the PMIC.

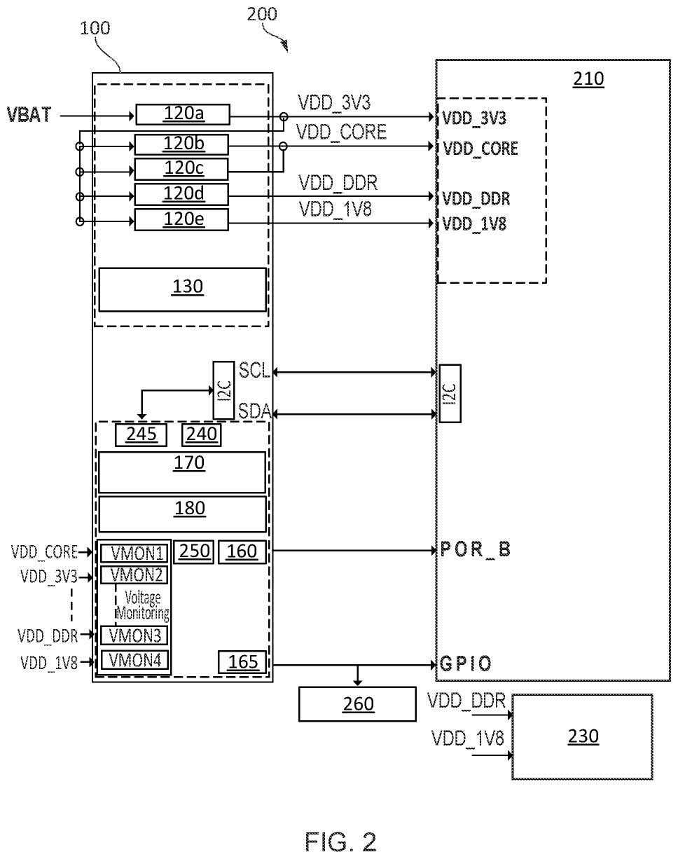

The safety unit may include an analogue built in self-test, ABIST, circuit (shown at 250 in FIG. 2) configured to test for the integrity and/or the correct operation of the voltage monitors. Furthermore, the safety unit may comprise a logic built in self-test, LBIST, circuit (shown at 240 in FIG. 2) configured to test for correct operation the safety monitoring unit and the safety sequencer. The LBIST circuit may check the integrity of the iSMU safety logic and the sequencer processing logic which may be integrated into the safety logic.

Turning now to FIG. 2, this shows a power management device 100 and in a system 200 which includes an application processor 210 and memory 230, according to one or more embodiments. The output of each of the power units within the power management device is provided to the application processor, in the example shown. In other embodiments, one or more outputs may be provided to other external devices such as external peripherals, for instance a controller area network (CAN) or ethernet device or an SD card, or the like. The memory device 230 is powered by the 1.8V supply along with the DDR supply. As mentioned above the power management device may include, in the safety processing domain or safety unit 150, an analogue built in self-test unit 250 (ABIST), for ensuring the integrity of the analogue circuits and in particular the voltage monitors 155. The power management device may also include, in the safety processing domain or safety unit 150, a logical built in self-test unit (LBIST) 240, for ensuring the integrity of the logical and/or digital circuit.

Also shown in FIG. 2 is a communication channel between the power management device and the application processor. As shown, the communication channel may be configured for I2C communication, with each of the power management device 100 and application processor 210 having an I2C interface 270 and 275 respectively. Where I2C interfaces are used, the connections are a clock line (SCL) and a data line (SDA). In other embodiments other communication links and/or other communication protocols might be used.

There may by a cyclic redundancy check 245, to checks that no data errors, such as flipped bits, occur in the transactions and communications between the power management device and the applications processor.

The power good output PGOOD 160 is connected to the applications processor 210 on the applications processor's power-on-reset pin POR_B, which typically is available to start or reset the device, and the output FS0B from the fail state unit 165 is connected to the application processor 210 on a general purpose input/output (GPIO) pin. This connection may be direct, or may be through an external peripheral, such as the system safe state transition unit mentioned below. The application processor is thereby enabled to take appropriate action on the discovery of a failure in the power management device. According to one or more embodiments this failure may include a failed power-up process.

The system may also include a system safe state transition unit 260. As will be familiar to the skilled person, such a unit may consist of additional logic or switches to transition the system in a controlled and known state. Without this, the system might be uncontrolled, depending on the nature of the failure.

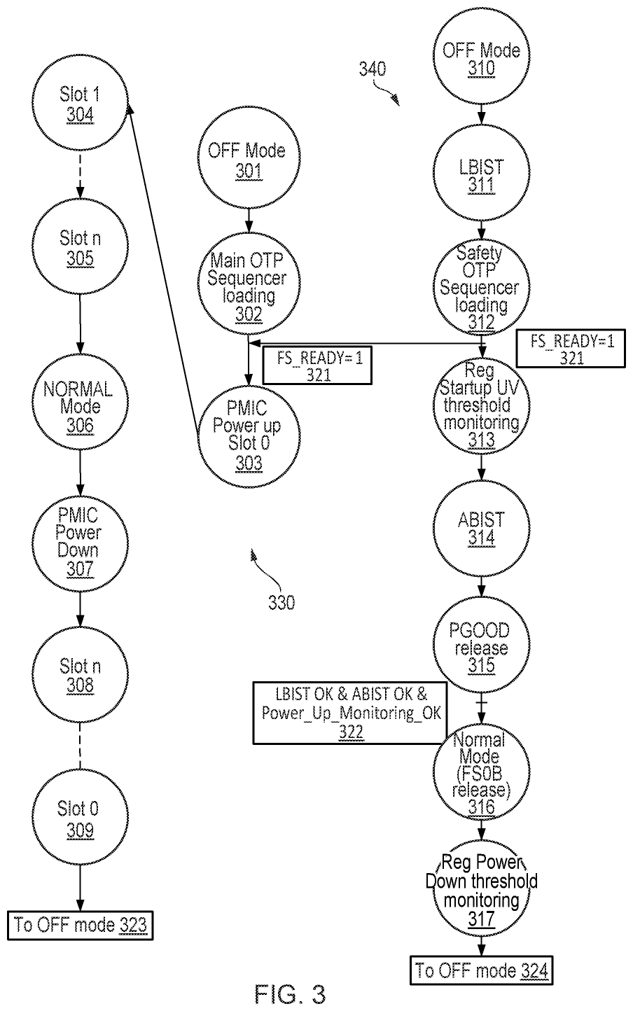

Turning now to FIG. 3, the figure shows state machines for both the power management processing 130 and the safety unit 108. The state machine 330 for the power management processing unit is generally on the left-hand side and the middle of the figure, and the state machine 340 for the safety unit is on the right-hand side of the figure.

The state machine for the power management processing unit is generally the same as for a conventional power management device: starting from an OFF mode 301, in this mode all of the power units of regulators are off, including the application processor under reset: typically, the PGOOD pin is used to maintain the application processor in the reset state; however, once the power-up sequence is complete, the PGOOD pin is released, which allows the application processor to start. The main sequencer is initiated at 302, by loading sequence information from the main sequencer into mirror registers from the non-volatile memory such as OTP memory. The initial power unit is powered up at 303. This power unit is conventionally considered to be in “slot 0” and the skilled person will be aware that it is conventional for this power unit to provide a 3.3 V supply. The remaining power units are then powered up with slot 1 being powered up at 304, through to the last power unit or units, in slot n, being powered up at 305. On completion of this the state machine moves to normal mode operation at 306. The power-down sequence is generally the reverse: so the state machine starts the power-down on receipt of a power-down command at 307, and powers down the power unit in the slots n at 308, and then sequentially powers-down the other power units until finally the first power unit in slot 0 is powered down at 309. The state machine then moves to OFF mode as shown at 323.

The state machine for the safety unit is shown at 340 on the right-hand side of FIG. 3. The safety unit starts in an off mode 310, and then may perform a logical built in self-test routine LBIST at 311. According to one or more embodiments of the present disclosure, the safety unit initiates the loading of the safety sequence from the non-volatile memory such as OTP memory in the safety sequencer as shown at 312 as “safety OTP sequencer loading”. It should be noted that there is an independency between the state machines of the power management processing unit and the safety unit, that is to say that the power management processing unit is prevented from transitioning from state 302 (“main OTP sequencer loading”) to state 303 (powering up the initial power unit), until the safety unit has completed step 312 (“safety OTP sequencer loading”) and is ready to start monitoring. Each state machine may indicate that it has reached this state, for instance by setting a respective flag FS_READY to be true as shown at 321. The state machines may then transition to their next state—in the case of the power management processing unit this is state 303 in which the initial power unit is powered up, and in the case of the safety unit the state machine moves to state 313 in which the safety unit starts monitoring threshold voltages to determine when each power unit crosses the undervoltage threshold (“regulator start-up UV threshold monitoring”).

Once all the power units have started up properly in the correct sequence (and optionally with the correct timing as discussed above) the safety unit state machine moves to the state 314 at which it may carry out an analogue built in self-test routine (ABIST). Upon successful completion of this the state machine moves to state 315 at which the power good unit is instructed to set the flag power good (“PGOOD release”).

At this time the safety unit has confirmed that the LBIST is OK, the ABIST is OK and the Power-up monitoring is OK, as shown at 322. Thus, in one of more embodiments, even if one or other of the LBIST and ABIST fails, the PGOOD pin may be released—which may for instance allow from some debugging or diagnostics to take place, whilst the FS0B pin is not released.

The state machine then transitions to normal mode and instructs the fail-state unit to release FS0B, as shown at state 316.

The safety unit state machine remains in this state until the power management device starts to power-down the power units, at which point the safety state machine moves to state 317 (“regulator power-down threshold monitoring”). On successful completion of this process, the safety unit state machine moves to an OFF mode 324.

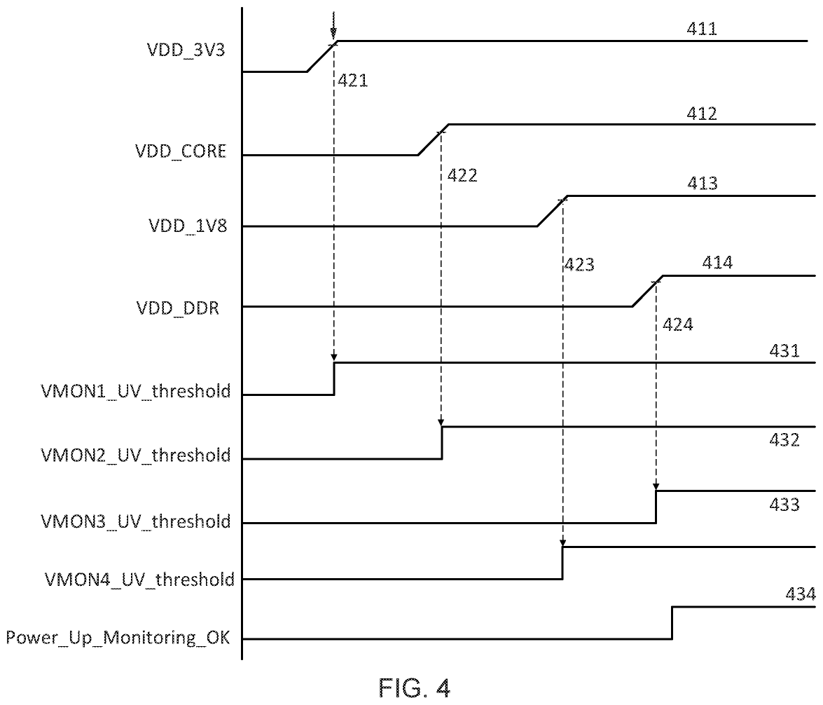

FIG. 4 shows an example timeline of a successful start-up sequence for a power management device as shown in FIG. 1. The figure shows, at the top four curves, the output voltage from each of four power units or regulators, which are intended to be powered up in sequence. It also shows at the bottom four curves, signals associated with each of the voltage monitors. As can be seen at 411 the 3.3 V DC-DC converter is powered up first, and the voltage on its output ramps up from a low value (nominally zero) to the expected value (3.3 V). During this ramp up, the output voltage crosses the undervoltage threshold (which may be set to for instance 3.0 V as discussed above). This moment is shown as 421 on the figure. At this time the output VMON1_UV_THRESHOLD of the voltage monitor associated with the 3.3 V power supply comparing the output voltage with the undervoltage threshold goes high, as shown on curve 431.

Similarly, and after this unit is operational, the DC-DC converter or converters for VDD_CORE is or are powered up as shown at 412, and the voltage on its or their output ramps up from a low value (nominally zero) to the expected value (VDD_CORE). During this ramp up, the output voltage crosses the undervoltage threshold (which may be set to for instance 10% below the nominal voltage, as discussed above). This moment is shown as 422 on the figure. At this time the output VMON2_UV_THRESHOLD of the voltage monitor associated with the VDD_CORE power supply comparing the output voltage with the undervoltage threshold goes high, as shown on curve 432.

Similarly, and after this or these units is or are operational, the power unit for VDD_1.8V (note that this may typically be an LDO) is powered up as shown at 413, and the voltage on its output ramps up from a low value (nominally zero) to the expected value (VDD_1V8). During this ramp up, the output voltage crosses the respective undervoltage threshold (which may be set to for instance 10% below the nominal voltage, as discussed above). This moment is shown as 423 on the figure. At this time the output VMON3_UV_THRESHOLD of the voltage monitor associated with the VDD_1V8 power supply comparing the output voltage with the undervoltage threshold goes high, as shown on curve 433.

Finally (in this example) after this unit is operational, the DC-DC converter or converters for VDD_DDR is powered up as shown at 414, and the voltage on its output ramps up from a low value (nominally zero) to the expected value (VDD_DDR). During this ramp up, the output voltage crosses the respective undervoltage threshold (which may be set to for instance 10% below the nominal voltage, as discussed above). This moment is shown as 424 on the figure. At this time the output VMON4_UV_THRESHOLD of the voltage monitor associated with the VDD_DDR power supply comparing the output voltage with the undervoltage threshold goes high, as shown on curve 434.

Once all the power units have successfully powered up, and the safety unit has established that the output voltages have each passed the respective undervoltage threshold, the unit sets the flag Power_Up_Monitoring_OK to high. The skilled person will appreciate that this may be effected by suitable logic circuitry combining individual monitor flags for each slot or power unit, and the it's also possible to have a dedicated flag for each VMON for debug purposes.

The skilled person will appreciate that the timing diagram shown in FIG. 4 corresponds to one of the simplest embodiments discussed herein. In other embodiments, the threshold monitor signals may not latch high when the threshold is passed—in such embodiments, even after the specific power unit has powered up, the monitor may detect and undervoltage if the power voltage from that unit subsequently dips below the threshold.

In other embodiments the timing diagram may include a time of which commences as each threshold signal 431,432, 433 goes high, and the power monitoring okay is latched low if the subsequent threshold signal does not pass go high within a predetermined time limit.

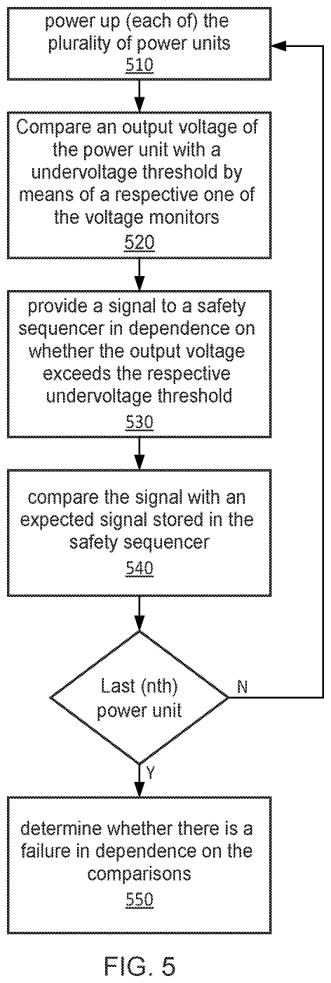

FIG. 5 shows a flow diagram of a method according to the present disclosure. The method of operating a power management device, which comprises a power management processing unit having a plurality of power units, and a safety unit having a plurality of voltage monitors. The method comprises, at step 510, powering up each of the plurality of power units according to a predetermined sequence stored in a main sequencer.

While the power unit is being powered up, an output voltage of the respective power unit is compared with a respective undervoltage threshold by means of a respective one of the voltage monitors as (shown at 520), and a signal provided to a safety sequencer in dependence on whether the output voltage exceeds the respective undervoltage threshold (shown at 530);

The signals are compared to a set of expected signals stored in the safety sequencer (shown at 540); and it is determined whether there is a failure in dependence on the comparisons (at 550)

Determining whether there is a failure in dependence on the comparisons (at 550) may be done by: providing a power-good signal in response to all the respective signals matching the set of expected signals; and providing a fail-state signal in response to any of the respective signals not matching the set of expected signals.

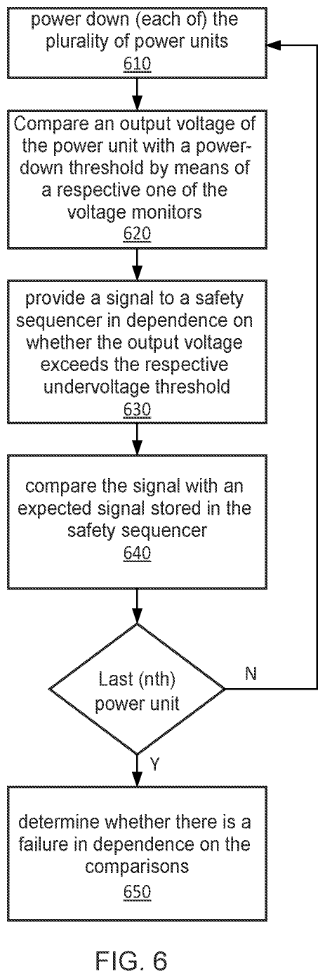

FIG. 6 shows as flow diagram of a method according to the present disclosure. The method is a method of operating a power management device comprising a power management processing unit having a plurality of power units, and a safety unit having a plurality of voltage monitors. The method comprises: at step 610, powering down each of the plurality of power units according to a predetermined sequence stored in a main sequencer.

At step 620, output voltage of the respective power unit while it is being powered up is compared an with a respective power-down voltage threshold by means of a respective one of the voltage monitors, and at step 630 a signal is provided to a safety sequencer in dependence on whether the output voltage exceeds the respective power-down threshold.

At step 620 the signals are compared with a set of expected signals stored in the safety sequencer; and at step 650 it is determined whether there is a failure in dependence on the comparisons.

Determining whether there is a failure in dependence on the comparisons may be done by providing a power-down-good signal in response to all the respective signals matching the set of expected signals; and providing a fail-state signal in response to any of the respective signals not matching the set of expected signals.

From reading the present disclosure, other variations and modifications will be apparent to the skilled person. Such variations and modifications may involve equivalent and other features which are already known in the art of safety power management devices, and which may be used instead of, or in addition to, features already described herein.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination. The applicant hereby gives notice that new claims may be formulated to such features and/or combinations of such features during the prosecution of the present application or of any further application derived therefrom.
For the sake of completeness it is also stated that the term “comprising” does not exclude other elements or steps, the term “a” or “an” does not exclude a plurality, a single processor or other unit may fulfil the functions of several means recited in the claims and reference signs in the claims shall not be construed as limiting the scope of the claims.

1. A power management device comprising
a power management processing unit and a safety unit;
the power management processing unit comprising:
an input configured to receive current at an input voltage (VBAT);
a plurality of power units each configured to supply current from the input at a respective output, and
a main sequencer configured to implement a power-up sequence in which the plurality of power units are powered-up to supply said respective current in a predetermined sequence;
the safety unit comprising:
a plurality of voltage monitors each configured to monitor the output voltage of a respective one of the power units;
a power-good unit, configured to provide a power-good output signal indicative of normal operation of the power management device;
wherein the safety unit further comprises a safety sequencer configured to store sequence data; and
wherein the safety unit further comprises a safety processing unit, configured to use the sequence data stored in the safety sequencer to monitor the plurality of power units during the power-up sequence by means of the respective voltage monitors, and to provide an output in response to the monitoring.

2. A power management device as claimed in claim 1,
wherein the safety unit comprises one-time programmable, OTP, memory.

3. A power management device as claimed in claim 1,
Wherein the main sequencer is further configured to implement a power-down sequence in which the plurality of power units are powered-down in a predetermined sequence, and the safety processing unit is further configured to monitor the power units during the power-down sequence by means of the respective voltage monitors, and to provide an output in response to the monitoring.

4. A power management device as claimed in claim 2,
wherein the main sequencer is further configured to implement a power-down sequence in which the plurality of power units are powered-down in a predetermined sequence, and the safety processing unit is further configured to monitor the power units during the power-down sequence by means of the respective voltage monitors, and to provide an output in response to the monitoring.

5. A power management device as claimed in claim 1,
wherein safety processing unit is configured to monitor the power plurality of power units during the power-up sequence by each voltage monitor comparing the output voltage of the respective power unit with a respective undervoltage threshold voltage, and the safety processing unit is configured to provide a threshold-passed signal indicative of whether the output voltage exceeds the respective undervoltage threshold voltage.

6. A power management device as claimed in claim 5,
wherein the safety sequencer is configured to store an expected sequence in which the power units should power up, and the safety processing unit is configured to provide an output to the power-good unit in response to the threshold-passed signals indicating the power unit powers up in expected sequence, and to the fail-state unit otherwise.

7. A power management device as claimed in claim 5,
wherein the safety sequencer is configured store an expected power-up interval for each power unit, and the safety processing unit is configured to provide an output to the power-good unit and response to receiving each of the respective threshold-passed signals indicating the power units have powered up within the respective predetermined interval in the same sequence as the expected sequence unit, and to the fail-state unit otherwise.

8. A power management device as claimed in claim 1,
wherein the safety processing unit is configured to provide an output to the fail-state unit in response to any one or more of the threshold-passed signals indicated that the respective power unit falls below the respective threshold after being powered up.

9. A power management device as claim 1,
wherein the plurality of power units comprises a plurality of DC-DC converters and at least one low drop out, LDO, voltage regulator.

10. A power management device as claimed in claim 1,
wherein the safety unit and the power management processing unit are included in a single integrated circuit.

11. A power management device as claimed in claim 1,
wherein the safety unit and a part of the power management processing unit are included in a single integrated circuit, and at least one of the power units are external to the integrated circuit.

12. A power management device as claimed in claim 1,
wherein the safety unit further comprises a fail-state unit, configured to provide an output indicative of a fail-state of the power management device, and wherein the safety processing unit is further configured to provide the output to at least one of the power-good unit and the fail-state unit in response to the monitoring.

13. A power management device as claimed in claim 1, wherein the power management processing unit further comprises a communication interface for communicating with an application processor, and wherein at least one of the plurality of power units are configured to provide power to the application processor.

14. A system comprising a power management device as claimed in claim 1, and an application processor connected to the power management device and configured to be powered the power management device.

15. A system as claimed in claim 14, further comprising a system safe state transition unit, connected to the power management device and the application processor and configured to control the application processor in dependence on the safety unit.

16. A method of operating a power management device comprising a power management processing unit having a plurality of power units, and a safety unit having a plurality of voltage monitors, the method comprising:
powering up each of the plurality of power units according to a predetermined sequence stored in a main sequencer;
comparing an output voltage of the respective power unit while it is being powered up with a respective undervoltage threshold by means of a respective one of the voltage monitors, and providing a respective signal to a safety sequencer in dependence on whether the output voltage exceeds the respective undervoltage threshold;
comparing the signals with a set of expected signals stored in the safety sequencer; and
determining whether there is a failure in dependence on the comparisons.

17. The method of claim 16, wherein determining whether there is a failure in dependence on the comparisons comprises
providing a power-good signal in response to all the respective signals matching the set of expected signals; and
providing a fail-state signal in response to any of the respective signals not matching the set of expected signals.

18. A method of operating a power management device comprising a power management processing unit having a plurality of power units, and a safety unit having a plurality of voltage monitors, the method comprising:
powering down each of the plurality of power units according to a predetermined sequence stored in a main sequencer;
comparing an output voltage of the respective power unit while it is being powered down with a respective power-down voltage threshold by means of a respective one of the voltage monitors, and providing a signal to a safety sequencer in dependence on whether the output voltage exceeds the respective power-down threshold;
comparing the signals with a set of expected signals stored in the safety sequencer; and
determining whether there is a failure in dependence on the comparisons.

19. The method of claim 18, wherein determining whether there is a failure in dependence on the comparisons comprises
providing a power-down-good signal in response to all the respective signals matching the set of expected signals; and
providing a fail-state signal in response to any of the respective signals not matching the set of expected signals.
